(19) United States
(12) Patent Application Publication
(10) Pub. No.: US 2001/0046583 A1
(43) Pub. Date: Nov. 29, 2001

(54) Stain-resistant polyamide fibers and articles comprising same

(76) Inventors: Phillip E. Wilson, Asheville, NC (US); Stanley A. McIntosh, Candler, NC (US); Matthew B. Hoyt, Arden, NC (US)

Correspondence Address: BASF CORPORATION, 26 DAVIS DRIVE, RESEARCH TRIANGLE PARK, NC, 27709, US

(21) Appl. No.: 09/860,061

(22) Filed: May 17, 2001

Related U.S. Application Data
(63) Continuation of application No. 08/715,724, filed on Sep. 19, 1996.

(51) Int. Cl. B32B 33/00; B32B 3/02; D04H 11/00; B32B 19/00; D02G 3/00; D05C 17/00; D03D 27/00

(52) U.S. Cl. 428/96; 428/373; 428/357; 428/85

(57) ABSTRACT

An acid-dye and coffee stain resistant carpet has sheath/core bicomponent face fibers affixed in a backing material and bound thereto. The face fibers have a core of a first polyamide component and a sheath which substantially or completely covers the core of a second polyamide component which is inherently chemically compatible with the first polyamide component. In an uncolored state, the carpet has a red drink staining depth of less than 15 CIE ΔE units and a coffee staining depth of less than about 10 CIE ΔE units.

### FIELD OF THE INVENTION

This invention relates to stain-resistant polyamide fibers and articles composed of such fibers. More particularly, this invention relates to articles such as carpets containing stain-resistant, sheath/core bicomponent fibers having a sheath of a first polyamide composition and a core of another polyamide composition.

### BACKGROUND OF THE INVENTION

The terms “stain” and “staining” as used herein with respect to polyamide fibers means the discoloration of such fibers caused by the binding of a colored material either ionically, covalently, or through chemical partitioning to the fiber. The term “stain resistant” and “stain resistance” as used herein with respect to polyamide fibers or carpets refers to the ability of the fiber or carpet to resist red drink and coffee stains. “Red drink staining depth” refers to the CIE total color difference (ΔE) between stained and unstained carpets as quantified using a spectrophotometer when stained carpets are stained according to AATCC method 175-1992. Red drink is commonly used as an exemplary acid dye type stain. “Coffee staining depth” refers to the CIE total color difference (A E) between stained and unstained carpets as measured using a spectrophotometer when carpets are stained by AATCC method 175-1992 except that 5.6 g/l of Folger's® instant coffee (150° C.) is substituted for the red drink. “Inherently chemically compatible” means that the materials referred to are miscible.

Polyamide fibers are relatively inexpensive and offer a combination of desirable qualities such as comfort, warmth and ease of manufacture into a broad range of colors, patterns and textures. As a result, polyamide fibers are widely used in a variety of household and commercial articles, including, e.g., carpets, draperies material, upholstery and clothing. Carpets made from polyamide fibers are a popular floor covering for both residential and commercial applications.

However, polyamide fibers tend to be easily permanently stained by (certain natural and artificial colorants such as those found in such common household beverages as coffee, wine and soft drinks. Such household beverages may contain a variety of colored anionic compounds including acid dyes. The stains resulting from such compounds cannot easily be removed under ordinary cleaning conditions.

The ability of a staining material like an acid dye to bind to a fiber is a function of the type of active functional groups on the fiber and of the staining material. For example, polyamides usually have terminal (often protonated) amine groups which bond with negatively charged active groups on an acid dye (or staining agent).

A commonly used acid dye colorant and one which severely stains nylon at room temperature is C.I. Food Red 17, also known as FD&C Red Dye 40. Acid dyes such as C.I. Food Red 40 often form strong ionic bonds with the protonated terminal amine groups in the polyamide polymers, thereby dyeing, i.e., staining, the fiber. Therefore, in contrast to soils which are capable of being physically removed from the polyamide carpet by recognized cleaning procedures, acid dye colorants such as C.I. Food Red 17 penetrate and chemically react with the polyamide to form bonds therewith which make complete removal of such colorants from the polyamide fibers impractical or impossible.

The exact mechanism of coffee as a staining agent is not well understood. However, as with acid dyes stains, coffee stains are notoriously difficult to remove with conventional cleaning procedures.

This severe staining of carpeting is a major problem for consumers. In fact, surveys show that more carpets are replaced due to staining than due to wear. Accordingly, it is desirable to provide polyamide fibers which resist common household stains like acid dye and coffee stains, thereby increasing the life of the carpet.

Methods to decrease the acid dye affinity of nylons are known. For example, U.S. Pat. No. 3,328,341 to Corbin, et al. describes decreasing nylon dyeability with butrylactone. U.S. Pat. No. 3,846,507 to Thomm et al. describes reducing acid dye affinity of polyamide by blending a polyamide with a polymer having benzene sulfonate functionality. U.S. Pat. No. 5,108,684 to Anton et al. describes fibers made from nylon copolymers containing 0.25 to 4.0 percent by weight of an aromatic sulfonate, which are stain-resistant to acid dyes. In U.S. Pat. No. 5,340,886, Hoyt et al. describe acid-ye resistant nylon fibers made by incorporating with in the polymer sufficient SO₃H groups or salts thereof to give the polymer a sulphur content of between about 1- and about 160 equivalents per 10⁶ grams polymer and, chemically blocking with a chemical blocking agent a portion of amine end groups present in the sulfonated polymer. Modified polymers such as described in these patents are generally expensive to make.

In addition to polymer modifications, topical treatments for carpets have been proposed as a cost effective means to impart acid dye resistance to polyamide carpet fibers. These topical treatments may be sulfonated materials that act as “colorless dyes” and bind the amine dye sites on the polyamide polymer. Sulfonated products for topical application to polyamide substrates are described in, for example, U.S. Pat. No. 4,963,409 to Liss et al.; U.S. Pat. No. 5,223,340 to Moss, III et al.; U.S. Pat. No. 5,316,850 to Sargent et al.; and U.S. Pat. No. 5,436,049 to Hu. Hu describes also a nylon substrate that is from a nylon polymer melt mixed with an amine end group reducing compound prior to fiber formation. Topical treatments tend to be non-permanent and to wash away with one or more shampoos.

Fibers may be formed in a variety of shapes and from a variety of materials. For example, some fibers have more than one type of polymer in distinct portions of the transverse cross-section and extending along the length of the fiber. Fibers that have two such portions are known as “bicomponent fibers”. Bicomponent fibers having one of the portions surrounding or substantially surrounding the other are referred to as having a sheath core configuration. Sheath/core bicomponent polyamide fibers are known.

U.S. Pat. No. 5,445,884 to Hoyt and Wilson discloses a filament with reduced stainability having a polyamide core and a sheath of a hydrophobic polymer. The weight ratio between the core and sheath is from about 2:1 to about 10:1. If the sheath is very thin, a compatibilizer must be used. Compatibilizers are generally expensive. The compatibilizer can, in some cases, be eliminated by making the sheath relatively thick, i.e., more than 15 wt % of the cross-section. However, if the sheath material is expensive, this also can add significantly to the cost of the fibers.

U.S. Pat. No. 4,075,378 to Anton discloses sheath/core bicomponent polyamide fibers containing a polyamide core and a polyamide sheath. The core polyamide is acid-dyeable while the sheath polyamide is basic-dyeable due to sulfonation.

U.S. Pat. No. 3,679,541 to Davis et al. describes a sheath/core bicomponent filament having soil-release, anti-soil redeposition and antistatic properties through use of a copolyester or copolyamide sheath around a polyamide core.

U.S. Pat. No. 3,645,819 to Fujii et al. discloses polyamide bicomponent fibers for use in tire cords, bowstrings, fishing nets and racket guts. The Fujii fibers are round fibers of “multicore” or “islands-in-the-sea” configuration.

U.S. Pat. No. 3,616,183 to Brayford discloses polyester sheath/core bicomponent fibers having antistatic and soil-release characteristics.

U.S. Pat. No. 2,989,798 to Bannerman describes sheath/core bicomponent which is said to have improved dyeability by modifying the amine end group level of the sheath relative to the core. The sheath has less amine end groups than the core.

Fibers that are non-round in transverse cross-section are known. For example, U.S. Pat. Nos. 2,939,202 and 2,939,201 both to Holland describe fibers having a trilobal cross-section.

### SUMMARY OF THE INVENTION

The present invention is an acid-ye and coffee stain resistant carpet. The carpet comprises a backing material with acid-ye and coffee stain resistant sheath/core bicomponent face fibers affixed in the backing material and bound thereto. The face fibers have a core of a first polyamide component and a sheath, which substantially or completely covers the core, of a second polyamide component and which is inherently chemically compatible with the first polyamide component. The second polyamide component comprises at least one stain resistant polyamide polymer selected from the group consisting of:

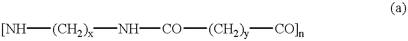

where x and y may be the same or different integers from about 4 to about 30 and the sum of x and y is greater than 13, and n is greater than about 40; and

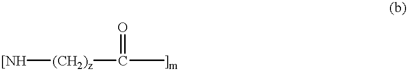

where z is an integer from about 9 to about 30, and m is greater than about 40;

(c) derivatives of (a) or (b), including polymers substituted with one or more sulfonate, halogenate, aliphatic or aromatic functionality; and

(d) copolymers and blends of (a), (b) and (c).

In an uncolored state, the carpet has a red drink staining depth of less than 15 CIE ΔE units and a coffee staining depth of less than about 10 CIE ΔE units.

It is an object of this invention to provide carpet which resists staining by acid dyes.

It is another object of this invention to provide carpet which resists staining by coffee.

Another object of this invention is to provide carpet, which in addition to having good stain resistance properties, is economical to make.

A still further object of the present invention is to provide a carpet made from a fiber exhibiting reduced steam heatsetting shrinkage.

The carpets of this invention are economical, durable and have lasting resistance to staining normally caused by acid dyes and coffee. Furthermore, since the chemical nature of the fibers used to make the carpet renders them stain-resistant, the stain resistance of the fibers is permanent. Because the relatively expensive stain resisting feature may be present only in a relatively thin sheath, production costs are conserved. This integration of the stain resistance is a significant improvement over topically applied stain-resist agents.

These and other objects and advantages which are achieved by the present invention can be readily discerned by those of ordinary skill in the art from the following description.

### BRIEF DESCRIPTION OF THE DRAWING

FIG. 1 is a bar chart showing red drink staining depth, expressed in terms of ΔE values, of various carpets including carpets used in the invention.

FIG. 2 is a bar chart showing coffee staining depth, expressed in terms of ΔE values, of various carpets including carpets used in the invention.

FIG. 3 is a bar chart showing steam heatsetting shrinkage of various yarns including yarns used in the invention.

### DETAILED DESCRIPTION OF THE INVENTION

To promote an understanding of the principles of the present invention, descriptions of specific embodiments of the invention follow and specific language is used to describe them. It will nevertheless be understood that no limitation of the scope of the invention is intended by the use of specific language. Alterations, further modifications and such further applications of the principles of the invention discussed are contemplated as would normally occur to one ordinarily skilled in the art to which the invention pertains.

Carpets made according to the present invention resist staining caused by both acid dyes and coffee. These carpets are made from bicomponent polyamide face fibers composed of a polyamide core phase substantially or completely surrounded by a stain-resistant polyamide sheath phase. The fiber of this invention preferably contains from about 97% by weight to about 10% by weight of the core phase and from about 3% by weight to about 90% by weight of the sheath phase. More preferably, the fiber used in the carpet of this invention contains from about 90% by weight to about 70% by weight of the core phase and from about 10% by weight to about 30% by weight of the sheath phase. Most preferably, the fiber contains from about 90% by weight to about 85% by weight of the core phase and about 10% by weight to about 15% by weight of the sheath phase.

The core and sheath polyamides of the fiber may be formed from any fiber-forming linear polyamide or copolyamide or any polyamide-forming monomers, so long as the sheath polyamide (i.e., “the second polyamide component”) is stain resistant.

Fiber-forming polyamides suitable for use in the present invention include polymers having, as an integral part of the polymer backbone chain, recurring amide groups (—CO—NR—) where R is an alkyl, aryl, alkenyl, or alkynyl substituent. Non-limiting examples of such polyamides include homopolyamides and copolyamides which are obtained by the polymerization of lactam or aminocaproic acid or a copolymerization product from any of the possible permutative mixtures of diamines, dicarboxylic acids or lactams.

The core polyamide (i.e., “the first polyamide component”) of the fiber used in this invention may be an acid-dyeable polyamide such as a polyamide having amine end groups available as dye sites. Such polyamides and methods of forming them are well known to those ordinarily skilled in the art. Preferable exemplary core polyamides include nylon 6 and nylon 6,6. Other polyamides such as nylon 12, nylon 11, nylon 6/12, nylon 6/10, etc., that have been modified so that they have become stainable with acid dyes or coffee, may be used. Most preferably, the core polyamide is nylon 6 or nylon 6/6.

Possibly the core polyamide may have an amine end-group content of from greater than about 5 milliequivalents per kilogram (meq/kg) to less than about 100 milliequivalents per kilogram, more preferably from about 20 to about 50 milliequivalents per kilogram. Those of ordinary skill in the art will readily recognize that amine end-groups in the polymer chain include secondary and tertiary amine groups. Secondary and tertiary amines are detectable in potentiometric titration curves for amine end-groups as a second weak break. The term amine “equivalents” includes all tritratable amine groups (primary, secondary and tertiary)detected.

The sheath phase of the fiber is composed of a second polyamide component. The second polyamide component includes an acid dye and coffee stain resistant polyamide polymer. The polyamide used in the sheath phase is resistant to acid dyes such that when the face fiber is exposed to C.I. Red No. 17, the red drink staining depth of the face fiber is about 15 or less CIE ΔE units under the Daylight 6500 Standard Illuminant. More preferably, the red drink staining depth is about 10 or less ΔE units. The sheath polyamide is resistant to coffee stains such that when the face fiber is exposed to coffee, the coffee staining depth under Daylight 6500 Standard Illuminant is about 10 or less CIE ΔE units.

The sheath polymer may be a polyamide selected from the group consisting of polyamides having the structure:

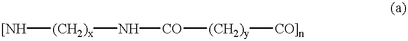

where x and y may be the same or different integers, preferably from about 4 to about 30 and the sum of x and y is greater than 13, more preferably from about 9 to about 20, and most preferably from about 9 to about 15 and n is greater than about 40; and

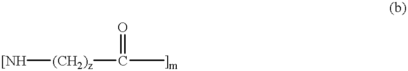

where z is an integer preferably from about 9 to about 30, more preferably from about 9 to about 20, and most preferably from about 9 to about 15 and m is greater than about 40;

(c) derivatives of (a) or (b) including polymers substituted with one or more sulfonate, halogenate, aliphatic or aromatic functionality; and

(d) copolymers and blends of (a), (b) and (c).

The preferable sheath polymers have greater than 80% of the non-carbonyl backbone or substituent carbons as alkyl, alkenyl, alkynyl, aryl, fluoroalkyl, fluoroalkenyl, fluoroalkynyl, fluoroaryl, chloroalkyl, chloroalkenyl, chloroalkynyl, chloroaryl, and the like, and do not have polar substituents such as hydroxy, amino, sulfoxyl, carboxyl, nitroxyl, or other such functionalities capable of hydrogen-bonding. Non-limiting examples of suitable fiber-forming polyamides which can be used as the sheath polyamide component include nylon 6/10; nylon 6/12; nylon 11; and nylon 12. The fiber-forming sheath polyamide may be sulfonated but is preferably substantially sulfonate-free. Most preferably, the sheath polymer is nylon 6/12.

The sheath polyamide component may also be amine end group blocked and preferably is so. Preferably, the polyamide polymer in the sheath phase of the fiber has a titratable amine-end-group concentration of preferably less than about 30 meq/kg, more preferably less than about 15 meq/kg, and most preferably less than 5 meq/kg. Such an amine-end-group-blocked polyamide polymer can be prepared, for example, by reacting a fiber-forming polyamide (e.g., one of the fiber-forming polyamides listed previously herein) with an amino end-group-blocking agent to chemically block a number of the amine end-groups present in the polyamide.

The amine end group blocking agent may be incorporated into the fiber-forming polyamide in a number of ways. For example, the agent may be added directly to a melt of the polymer prior to fiber formation. In one method, the agent is added to chips of the polyamide prior to melt formation. Preferably, the blocking agent is added to the polyamide chips immediately after the chips have been tumble-dried to remove excess moisture and are, therefore, still hot, e.g., having a temperature of 90-95° C. The chips and the blocking agent are thoroughly tumbled or otherwise mixed to produce a uniform mixture of chips and blocking agent prior to melt formation. Thereafter, the chips are passed to a conventional melting device and extruded at an appropriate temperature, which is preferably a temperature ranging from about 265° C. to about 300° C. In another method, the amine end group blocking agent is introduced via a metering device to a conventional melting device along with chips of the polyamide. The polyamide and the blocking agent are then melted together.

Suitable amine-end-group blocking agents are known to those ordinarily skilled in the art and include, for example, lactones and anhydrides. Examples of anhydrides which can serve as the amino end-group blocking agent in this invention include, e.g., acetic anhydride, maleic anhydride, glutaric anhydride, benzophenonetetracarboxylic dianhydride, naphthalene tetracarboxylic dianhydride, benzenetetracarboxylic dianhydride, cyclobutanetetracarboxylic dianhydride, succinic anhydride, benzoic anhydride, acetic formic anhydride, and other carboxylic anhydrides.

The preferred amine-end-group-blocking agents for use in the present invention are lactones, more preferably, caprolactones and butyrolactones. Most preferably, the amine-end-group-blocking agent used in the present invention is an epsilon-caprolactone.

The amount of the amine-end-group blocking agent added to the fiber-forming polyamide to form the sheath polyamide polymer depends on the results desired and the particular polyamide used. Preferably, amounts exceeding about 0.2% by weight based on the weight of the polyamide will be used. While there is generally no upper limit to the amount of amine-end-group blocking agent which can be added, it is currently preferred that the amount used not exceed about 3% by weight based on the weight of the polyamide. For example, when epsilon-caprolactone is used as the blocking agent, the amount of the epsilon-caprolactone will preferably range from about 0.5% by weight to about 2% by weight based on the weight of the polyamide.

Optionally, the fiber may be solution-dyed by incorporating one or more colorants into the polymer prior to spinning the fiber. As used herein, the term “colorant” means a coloring agent which is a water-soluble, organic-soluble dye, polymer-soluble dye, pigment or any other color-imparting agent. The colorants are generally introduced in the form of a concentrate formulation containing one or more “pure” colorants in a polymer matrix. The number, color and amount of colorants added are dependent on the final color desired. In addition, the usual fiber additives (e.g., delusterants, antioxidants, heat stabilizers, etc.) may be added to the polyamides before spinning.

As mentioned previously, the sheath phase preferably substantially or completely covers the core phase of the fiber used in this invention. Methods for forming sheath/core fibers are known to those of ordinary skill in the art. One preferred method of forming sheath/core fibers is described in U.S. Pat. No. 5,162,074 to Hills, which is hereby incorporated by reference for the bicomponent spinning techniques taught therein. The sheath/core arrangement may be eccentric or concentric.

The fibers used as face fiber in the carpet of this invention are preferably multilobal. Trilobal cross-sections are currently preferred.

Common melt-spinning and after processing techniques may be employed to make the fibers. The fibers may be crimped to produce bulked yarns by known methods including stuffer-box crimping, gear-crimping, edge-crimping, false-twist texturing and hot-fluid jet bulking.

The fibers used in this invention may be continuous fibers or staple fibers alone or in admixture with other fibers, particularly where stain resistance is important. The fibers are particularly useful as bulked continuous filament yarns.

The carpet of the present invention may be made by conventional carpet making techniques like weaving or tufting the face fibers into a backing material and binding the face fiber to the backing with latex or other adhesives. The carpet of the present invention may be foam backed. The carpet may be tufted or level loop. The carpet of the present invention may be in the form of carpet tiles, with or without foam backing.

The carpeting of the present invention may be made according to standard carpet making techniques for making cut pile carpeting that are readily known to those of ordinary skill in the art. For example, the sheath/core fiber described above may be plied into yarn, twisted and heatset. Several ends may be combined in a variety of manners and twist levels according to conventional techniques. Then it is tufted into a primary backing and cut to form cut pile carpeting. The primary backing may be woven or non-woven jute, nylon, polyester, polypropylene, etc. The cut pile carpeting is dyed to the desired shade. A secondary backing is adhered to the non-pile side, typically using a latex-based adhesive. The secondary backing may be jute, polypropylene, nylon, polyester, etc.

The carpet of the present invention can be a variety of pile weights, pile heights and styles. There is not currently believed to be any limitation on the carpet style.

Nylon yarns will often shrink during heatsetting. Preferably, the fiber used in this invention has a steam heatsetting shrinkage value of about 70% or less relative to the steam heatsetting shrinkage value of fiber which is manufactured in the identical manner but which consists only of the core polyamide component.

The invention will now be described by referring to the following detailed examples. These examples are set forth by way of illustration and are not intended to be limiting in scope. Knit fabrics are used in some of the following examples to demonstrate the stain resisting nature of fibers useful to make carpets of the present invention. This is merely for illustration and it is believed that the fibers would exhibit substantially identical attributes as face fiber in carpet. EXAMPLES 1-3

In Examples 1-3, six (6) fabric samples, prepared from three (3) different types of polyamide fibers, are tested for stain resistance to acid dyes and to coffee. Examples 1 and 3 are comparative fabric samples. Example 2 is prepared according to the invention.

For Examples 1-3, 3520 denier 52 filament round bicomponent fiber yarn is prepared by co-melt-spinning the core polyamide and the sheath polyamide using a 52-hole, concentric, sheath/core spin pack fed by two extruders. The 3520 denier 52 filament yarn is drawn and fluid jet textured using conventional means known to those skilled in the art to a final denier of 940. Each textured yarn is knitted into a fabric sample.

The respective fibers made in the examples are as follows:

Example 1 (comparative): bicomponent fiber having a nylon 6 “core” and a nylon 12 “sheath”, with a sheath:core weight ratio of 50:50, but the sheath does not form a continuous covering over the core.

Example 2 (invention): bicomponent fiber having a nylon 6 core and a nylon 6/12 sheath, with a sheath:core weight ratio of 50:50.

Example 3 (comparative): nylon 6 is spun in both the core and the sheath at a weight ratio of 50:50. This example represents typical monocomponent fibers.

The acid dye and coffee stain resistance of the various fabric samples of Examples 1-3 is determined as described. The total color differences, reported as ΔE values, between stained and corresponding unstained samples are calculated using the CIE L*a*b* system as described by the Commission Internationale de l'Eclairage in CIE Publication No. 15 (E-1.3.1) for a Daylight 6500 standard illuminant. Results are reported in Table I.

Generally, in the method used in Examples 1-3, a ΔE value of less than 5 is considered essentially unstained; a ΔE value of 5 to 10 indicates very light staining; and a ΔE value of greater than 10 is considered significantly stained. However, for uncolored or lightly colored substrates (carpets or fabrics), stains may have a total color difference greater than those given above and may serve as very acceptable anti-staining substrates when used in more deeply colored materials. Uncolored carpet or fabric serves as a “worst case” example. A colored substitute will mask the degree of color change due to staining.

### Stain Resistance to Coffee

The fabric samples prepared in Examples 1-8 are tested for stain resistance to coffee. The coffee stain-resistance tests are carried out in the following way.

A brew of coffee is prepared using 5.6 grams per liter of Folger's instant coffee, which is heated to 150° F. Each fabric sample to be tested is covered with a quantity of the instant coffee liquid such that the mass of coffee is from 1 to 2.5 times the mass of the fabric sample. The stains are allowed to remain on the fabric samples for twenty (20) minutes, after which the fabric samples are allowed to dry for 24 hours. After 24 hours, the samples are rinsed with cold water, extracted and tumble-dried.

The results of the coffee stain-resistance tests for the fabric samples prepared in Examples 1-3 are presented in Table I.

### Stain Resistance to C.I. Food Red 17

The red drink stain resistance tests in Examples 1-3 are carried out as follows:

A solution of 80 mg FD&C Red No. 40 (C.I. Food Red 17) per liter of water is prepared. Each sample is placed individually in a 10:1 bath ratio of the C.I. Food Red 17 solution for 5 minutes at room temperature. After five minutes, the samples are removed, lightly squeezed by hand to remove excess liquid and allowed to dry for 16 hours. After 16 hours, the samples are rinsed with cold water, extracted and tumble dried.

The results of the coffee stain resistance tests carried out in Examples 1-3 are presented in Table I below.

TABLE 1
Stain Resistance Analysis
Examples 1-3

| | Coffee Stain | Red Drink |
|---|---|---|
| Example No. | Depth (ΔE) | Stain Depth (ΔE) |
| 1 | 18.35 | 48.93 |
| 2 | 6.37 | 5.80 |
| 3 | 23.22 | 60.38 |

### Examples 4-8

In Examples 48, red drink staining depth is measured by spectrophotometer on samples stained according to AATCC Method 175-1992. Coffee staining depth is measured by spectrophotometer on samples stained according to AATCC Method 175-1992 except that 5 g/l of Folger's® Instant Coffee at 150° F. is substituted for the red drink.

Example 4 (Comparative)

Using nylon 6 (relative viscosity of 2.7; amino end group level of 37 milliequivalents/kg) an 1100 denier, 58 filament, textured bulked continuous fiber (BCF) yarn is spun using a spin, draw and texture (SDT) machine and conventional nylon 6 spinning conditions. A trilobal spinneret is used such that the filaments have a trilobal cross-section known as a “fox” cross section because of its resemblence to a fox's head. The polymer temperature in the spin pack is 270° C. A draw ratio of 2.8 is used. The winder speed is 2400 meters per minute.

Examples 5-8 (Invention)

Bicomponent yarns with a nylon 6,12 (Vestamid™ D16, from Hüls America, Inc. of Piscataway, N.J.) sheath/nylon 6 core are made as described in Example 4 using a bicomponent spin pack. The ratio sheath to core polymer varies as shown in Table II. The extrusion temperature of the nylon 6,12 is 270° C.

Yarns of Examples 4-8 are knitted into circular single jersey flat fabrics. These fabrics are stained using AATCC test procedure 175-1992, where the knitted fabric replaces the pile floor covering of the procedure. The method of rating the staining performance is different from AATCC 175-1992. A spectrophotometric measurement of the stained and unstained materials is made and the total color difference between the stained and unstained materials is calculated under the CIE La*b* system. For details of this calculation see, for example, Billmeyer, Principles of Color Technology. The lower the value of the total color difference (ΔE) the more the material has resisted staining. The results are presented in Table II.

The unstained knitted fabrics are also stained with coffee. The degree of staining is determined using the same method as described for the red drink stain immediately above. The results are presented in Table II.

The yarns of Examples 4-8 are cabletwisted to produce a twist level 3.75 tpi (twists per inch). This twist is then heatset using an autoclave. The heatset yarns are then tufted on an ⅛ gauge tufting machine to produce a 9/16″ pile height and 35 oz./square yard weight of face yarn in a cut pile carpet. The red drink staining depth and coffee staining depth of each carpet is measured. The results are presented in Table II.

Skeins of the cabled yarns were heatset in a steam autoclave using a temperature cycle of 270° F.-230° F.-270° F.-230° F.-270° F. Denier (or linear density) is determined using ASTM D1059, where the length of yarn used is 90 cm. Autoclave shrinkage is computed using the linear densities before and after the autoclave heatsetting of the yarn and using the formula:

shrinkage=(d_{after}−d_{before})/d_{after}

where d_{before} and d_{after} are the linear densities before and after the heatsetting treatments (Superba or Autoclave shrinkage). The results are presented in Table II.

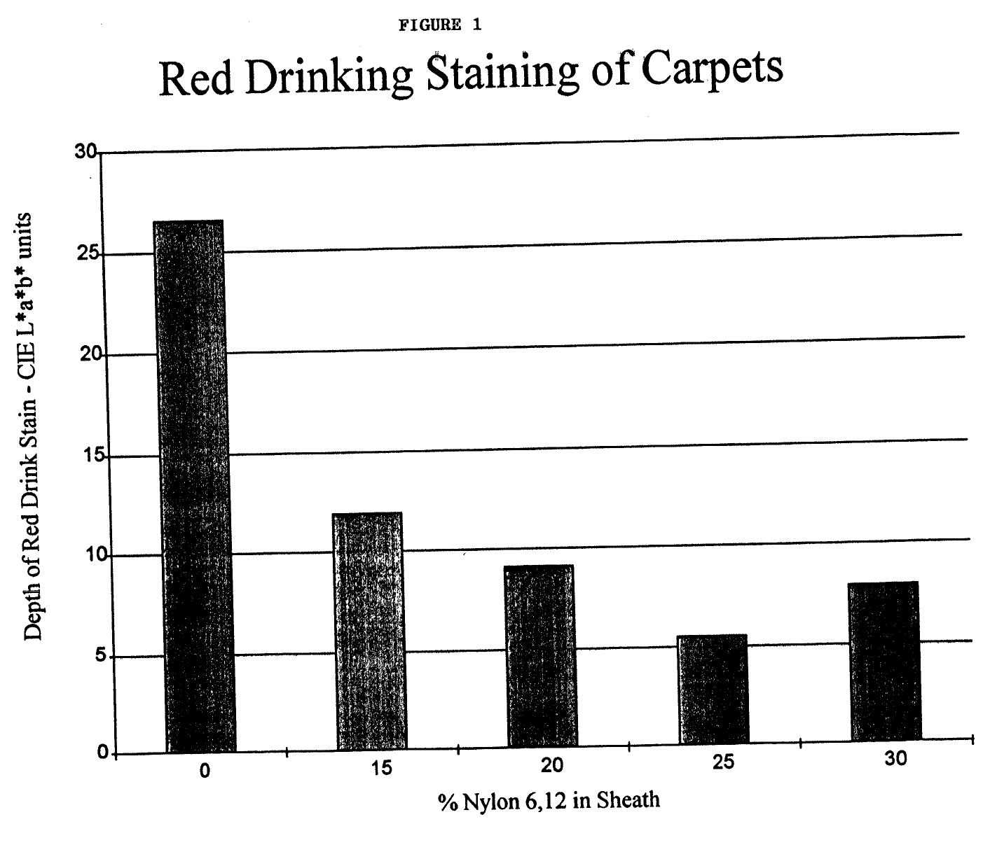

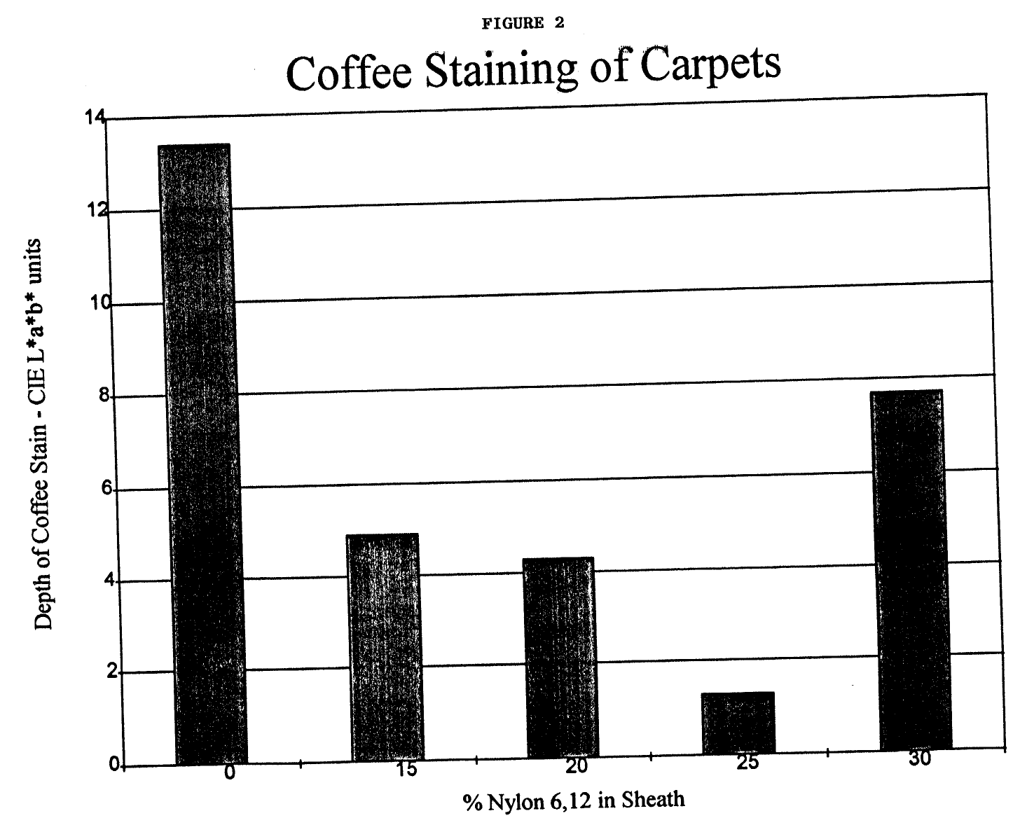

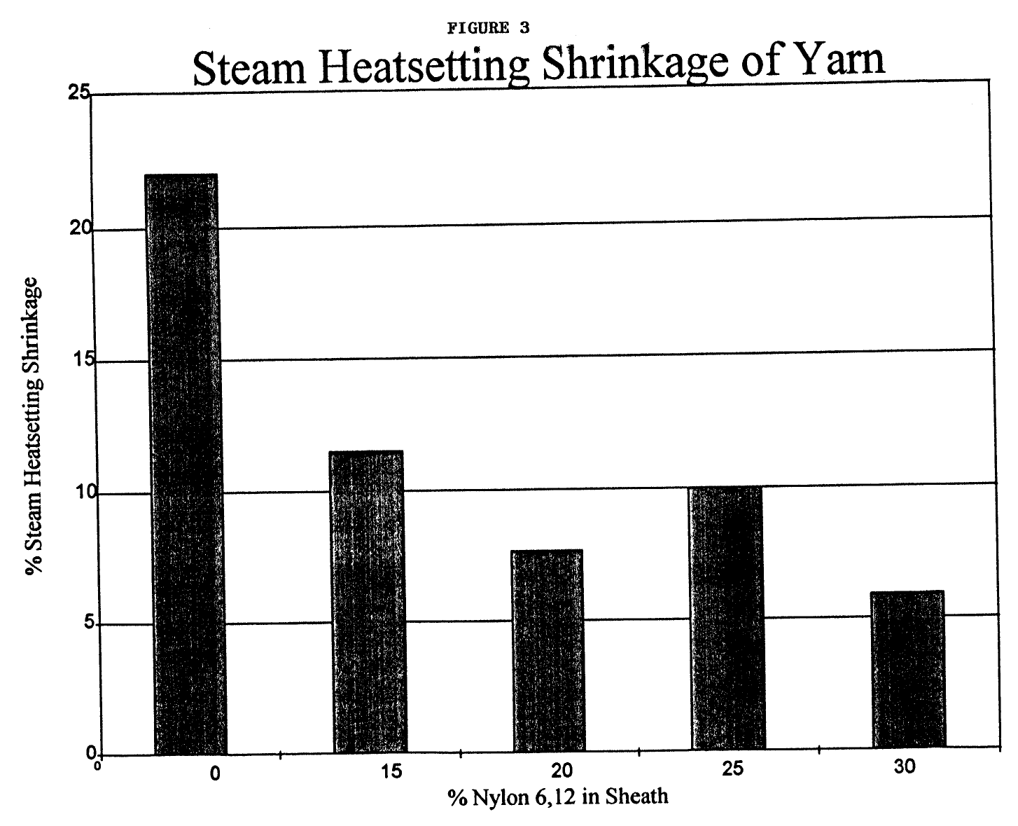

FIGS. 1-3 graphically illustrate the results of red dye staining depth, coffee staining depth and steam heatsetting shrinkage.

TABLE II
Examples 4-8
Stamina Differences
Total Color Difference (CIE L*a*b* ΔE)

| | | Knitted Fabrics | | Carpets | | % Steam |
|---|---|---|---|---|---|---|
| | Weight % | Red | | Red | | Heat- |
| Ex | Nylon 6, 12 | Drink | Coffee | Drink | Coffee | setting |
| No. | Sheath | Staining | Staining | Staining | Staining | Shrinkage |
| 4 | 0 | 56.5 | 9.7 | 26.5 | 13.4 | 22.0 |
| 5 | 15 | 6.3 | 4.7 | 11.9 | 4.9 | 11.5 |
| 6 | 20 | 5.6 | 5.1 | 9.1 | 4.3 | 7.7 |
| 7 | 25 | 5.0 | 4.9 | 5.5 | 1.3 | 10.0 |
| 8 | 30 | 5.1 | 4.2 | 7.9 | 7.7 | 5.9 |

What is claimed is:

1. An acid-dye and coffee stain resistant carpet comprising:
a backing material; and
stain resistant sheath/core bicomponent face fibers affixed in said backing material and bound thereto, said face fibers having a core of a first polyamide component; and a sheath substantially or completely covering said core and of a second polyamide component which is inherently chemically compatible with said first polyamide component, said second polyamide component comprising at least one stain resistant polyamide polymer selected from the group consisting of:
(a) 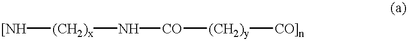
where x and y may be the same or different integers from about 4 to about 30, the sum of x and y is greater than 13, and n is greater than about 40; and
(b) 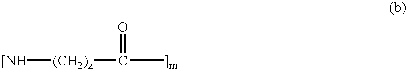
where z is an integer from about 9 to about 30 and m is greater than about 40;
(c) derivatives of (a) or (b) including polymers substituted with one or more sulfonate, halogenate, aliphatic or aromatic functionality; and
(d) copolymers and blends of (a), (b) and (c).
said carpet in an uncolored state having a red drink staining depth of less than 15 CIE ΔE units and a coffee staining depth of less than about 10 CIE ΔE units.

2. The carpet of claim 1, wherein said second polyamide component has a concentration of titratable amino end-groups less than 30 milliequivalents per kilogram.

3. The carpet of claim 2, wherein said concentration of titratable amino end-groups in said second polyamide polymer is less than 5 milliequivalents per kilogram.

4. The carpet of claim 1, wherein said second polyamide polymer is substantially sulfonate-free.

5. The carpet of claim 1, wherein said second polyamide polymer is nylon 6/12 or nylon 12.

6. The carpet of claim 1, wherein said non-polar functional groups comprise greater than 80% by weight of said non-carbonyl polymer carbons.

7. The carpet of claim 1, wherein said first polyamide component is selected from the group consisting of:
nylon 6;
nylon 12;
nylon 11;
nylon 6/6;
nylon 6/12;
nylon 6/10; and
combinations thereof.

8. The carpet of claim 1, wherein said first polyamide component is nylon 6/6 or nylon 6.

9. The carpet of claim 3, wherein said first polyamide component has an amine-end-group concentration from greater than about 5 to less than about 100 milliequivalents per kilogram.

10. The carpet of claim 9, wherein said first polyamide component has an amine-end-group concentration of from about 20 to about 50 milliequivalents per kilogram.

11. The carpet of claim 1, wherein said fiber comprises from about 10% by weight to about 97% by weight of said core phase and from about 90% by weight to about 3% by weight of said sheath phase.

12. The carpet of claim 11, wherein said fiber comprises from about 85% by weight to about 90% by weight of said core phase and from about 15% by weight to about 10% by weight of said sheath phase.

13. The carpet of claim 1, wherein said fiber has a non-round cross section.

14. The carpet of claim 13, wherein said fiber has a multilobal cross section.

15. The carpet of claim 14, wherein said fiber has a trilobal cross section.

16. The carpet of claim 1, wherein said fiber has a percent steam heatsetting shrinkage value which is about 70% or less of a percent steam heatsetting shrinkage value of an otherwise identical fiber consisting of only said first polyamide component.

17. The carpet of claim 1 wherein said red drink staining depth is less than about 10 ΔE units.

18. The carpet of claim 1 wherein x, y and z are each no more than 20.

19. The carpet of claim 18 wherein x, y and z are each no more than 15.
